(19) United States
(12) Patent Application Publication
(10) Pub. No.: US 2020/0099166 A1
(43) Pub. Date: Mar. 26, 2020

(54) WIREFORMED CONTACTS THAT CONSERVE RESOURCES

(71) Applicant: Apple Inc., Cupertino, CA (US)

(72) Inventors: Hani Esmaeili, Santa Clara, CA (US); Holly M. Ubellacker, Georgetown, KY (US); Daniel C. Wagman, Scotts Valley, CA (US); Jason S. Sloey, Cedar Park, TX (US); Eric S. Jol, San Jose, CA (US)

(73) Assignee: Apple Inc., Cupertino, CA (US)

(21) Appl. No.: 16/538,755

(22) Filed: Aug. 12, 2019

Related U.S. Application Data
(60) Provisional application No. 62/735,475, filed on Sep. 24, 2018.

(51) Int. Cl. H01R 13/533; H01R 13/03; H01R 13/504; H01R 13/66; H01R 43/02; H01R 43/16; H01B 1/02

(52) U.S. Cl. CPC H01R 13/533; H01R 13/03; H01R 13/504; H01R 2201/06; H01R 43/02; H01R 43/16; H01B 1/026; H01R 13/6675

(57) ABSTRACT

Connectors having contacts that can be highly corrosion resistant, can conserve precious materials, and can be readily manufactured. Examples can provide connector contacts that are highly corrosion resistant. These contacts can be formed of a precious metal or a precious-metal alloy. The precious-metal alloy can be a high-entropy alloy. To conserve the precious materials, a contact can be formed by a stamping a structure that becomes the contact, instead of stamping the contact from a structure. The structure can be a rod. To conserve the precious materials, only contacts that convey high voltages, such as power supplies, might be formed of the precious materials.

### CROSS REFERENCES TO RELATED APPLICATIONS

This application claims the benefit of U.S. Provisional Patent Application No. 62/735,475, filed on Sep. 24, 2018, which is incorporated by reference.

### BACKGROUND

Electronic devices often include one or more connector receptacles though which they can provide and receive power and data. Power and data can be conveyed over cables that include a connector insert at each end. The connector inserts can be inserted into connector receptacles in the communicating electronic devices.

These connector receptacles and connector inserts might be exposed to liquids and fluids that can cause their contacts to corrode. For example, a user might purposely or inadvertently submerge an electronic device or a connector insert in a liquid. A user can spill a liquid or perspire on contacts in a connector receptacle of an electronic device or connector insert. These actions can cause one or more contacts to corrode, particularly where a voltage is present on the one or more contacts. This corrosion can impair the operation of the electronic device or cable and in severe cases can render the electronic device or cable inoperable. Even where operation is not impaired, corrosion can mar the contacts' appearance.

To reduce this corrosion, contacts in a connector receptacle or connector insert can be formed or plated using corrosion resistant materials. But typically, contacts are stamped from a sheet of metal and the portion of the sheet of metal that remains after stamping can be recycled. Unfortunately, this recycling might not be a hundred percent efficient. That is, the amount of the metal remaining after stamping that is recoverable by recycling can be less than a hundred percent. This can result in some of the corrosion resistant materials not being recycled or otherwise recovered.

Also, some of these electronic devices become tremendously popular. As a result, connector receptacles on electronic devices and connector inserts on cables can be sold in very large quantities. Therefore, it can be desirable that these connectors be readily manufactured such that customer demand for them can be met.

Thus, what is needed are connectors having contacts that can be highly corrosion resistant, can conserve corrosion resistant materials, and can be readily manufactured.

### SUMMARY

Accordingly, embodiments of the present invention can provide connectors having contacts that can be highly corrosion resistant, can conserve precious materials, and can be readily manufactured. These contacts can be located in a connector insert, in a connector receptacle, or elsewhere in a connector system.

An illustrative embodiment of the present invention can provide connector contacts that are highly corrosion resistant. These contacts can be formed of a precious metal or a precious-metal alloy. When these contacts are formed of a precious-metal alloy, the precious-metal alloy can be a high-entropy alloy. For example, the contacts can be formed of material consistent with one of ASTM Standards B540, B541, B563, B589, B683, B685, or B731. Materials having a good formability and high elongation for improved manufacturability can be selected for use in manufacturing these contacts.

In these and other embodiments of the present invention, contacts in a connector can be plated with a hard, durable, wear and corrosion-resistant plating stack. This stack can be formed of one or more plating layers. This stack can include a top plate that forms a contacting surface to physically and electrically connect to a corresponding contact in a corresponding connector when the connector and the corresponding connector are mated. The stack can include other layers, such as leveling, isolation, adhesion, and barrier layers.

An illustrative embodiment of the present invention can provide connector contacts and methods of manufacturing contacts that can conserve precious materials. In these and other embodiments of the present invention, a connector can include a first set of contacts and a second set of contacts. The first set of contacts can be formed of a precious metal or a precious-metal alloy. The second set of contacts can be formed of a more common or readily available material, such as copper, copper-nickel-silicon, or other copper alloy. Since the first set of contacts are formed of a precious metal or a precious-metal alloy while the second set of contacts are formed of a more common material, the amount of precious metal or precious-metal alloy that is used in manufacturing the connector can be reduced.

Certain contacts in a connector can have an increased susceptibility to corrosion. For example, contacts that are often used to convey high voltages can be susceptible to corrosion. Accordingly, in these and other embodiments of the present invention, the first set of contacts can be contacts that often have a voltage applied on them. For example, the first set of contacts can be used to receive or provide power supply voltages. Accordingly, these power supply contacts can be formed of a precious metal or a precious-metal alloy. The second set of contacts can be used to convey ground or signals, and can be formed of a more common or readily available material. In these and other embodiments of the present invention, contacts that are adjacent to or near these contacts can also be formed using precious metal or a precious-metal alloy.

As one specific example, in a Lightning® connector receptacle, contacts for some or all of a power supply VBUS (pin 5), an accessory power supply ACC_PWR (pin 8), and an accessory identification pin ACC_ID (pin 4) can be formed using a precious metal or a precious-metal alloy or other material, while the remaining pins can be formed of a more common material. In a Universal Serial Bus Type-C connector insert, contacts for all or some of a power supply VBUS (pins A4, A9, B4, B9, connection detect CC1 (pin A5), and connector power VCONN (B5) can be formed using a precious metal, a precious-metal alloy, or other material, while the remaining pins can be formed of a more common material.

These and other embodiments of the present invention can reduce the amount of precious metal or a precious-metal alloy that is used by forming a structure that becomes the contact before the contact is stamped. That is, traditional contact stamping involves stamping a contact from a sheet of metal. The contact as stamped can have the shape for use in a connector, but the remainder of the sheet of metal then needs to be recycled if recovery of the remaining metal is desired. Instead of this, embodiments of the present invention can form a structure that becomes the contact. The structure is then stamped such that it forms a contact having a shape needed for use in a connector.

In these and other embodiments of the present invention, a rod can be used as a structure that is stamped to form a contact. The rod can have a cylindrical shape. The rod can be formed by extrusion, 3-D printing, metal-injection molding, or other additive or other process. The rod can then be stamped one or more times such that it has a shape needed for use as a contact in a connector. The one or more rods can then be plated and at least partially housed in a housing for use in the connector. By stamping a structure to form a contact, the amount of waste that can otherwise be generated can be reduced, particularly when compared to stamping contacts from a sheet of metal. This can conserve precious materials and reduce the amount of precious materials that needs to be recycled.

These and other embodiments of the present invention can reduce the amount of precious materials that are needed to manufacture contacts for a connector, thereby conserving valuable resources. This can allow the use of improved materials in manufacturing the contacts to further reduce corrosion.

An illustrative embodiment of the present invention can provide connectors that are readily manufactured. A first plurality of rods can be formed of a first material and a second plurality of rods can be formed of a second material. The first plurality of rods and the second plurality of rods can be attached to a first carrier. The rods can be attached by press-fitting the first plurality of rods and the second plurality rods to the first carrier, by inserting the first and second pluralities of rods in holes or openings in the first carrier, by stitching the first and second pluralities of rods in the first carrier, or by other method. A third plurality of rods can be attached to a second carrier, for example by press-fitting the rods to the second carrier, by inserting the third plurality of rods in holes or openings in the second carrier, by stitching the rods in the second carrier, or by other method. The first and second carriers can be stamped of a bulk material and the various rods can be attached to them. These carriers can be used to carry or otherwise manipulate or position the rods during further manufacturing steps, such as bending, blasting, polishing, sanding, plating, annealing, or other process steps.

For example, the first and second plurality of contacts can be then stamped in one or more stamping procedures. The third plurality of contacts can be stamped in one or more stamping procedures. The first carrier and the second carrier can be joined such that the first, second, and third pluralities of contacts form groups of contacts. The first, second, and third pluralities of contacts can be plated with one or more plating layers. A housing can be injection molded around midsections of each contact in the group of contacts. The housing can also support side ground contacts or other connector structures. Each group of contacts can then be cut or otherwise detached from the first and second carriers such that the housing, group of contacts, and side ground contacts and other connector structures (if present) can be assembled into a connector. The contacts and the first and second carriers can be arranged in such a way as to reduce the amount of precious materials that is cut away from the first plurality of contacts. The precious materials that are cut away can be recycled or otherwise recovered. The first carrier and the second carrier can be joined in a way that reduces the total amount of precious materials that are cut away.

In these and other embodiments of the present invention, these steps can be varied. For example, the first, second, and third pluralities of rods can be stamped and resulting contacts can be placed as a group in a mold for a housing. The housing can then be formed around midsections of each of the contacts in the group of contacts. The housing can also be formed around a portion of side ground contacts and other connector structures, if present. The housing, group of contacts, and side ground contacts and other connector structures can be assembled into a connector. One or more plating steps can occur at different times as well, particularly where only some contacts are formed of a precious metal or precious-metal alloy.

In these and other embodiments of the present invention, the rods or other structures can be stamped in one or more steps to give them the shape needed for use as a contact in a connector. For example, tail portions of the rods can be wire coined or stamped to have a flattened shape. The flattened (or at least flatter) shape can facilitate soldering of the tail portions to contacts or pads of a printed circuit board, flexible circuit board, or other appropriate substrate.

These rods can be stamped to have an approximately 45 degree bend near an approximately 90 degree bend. These bends can be near each other and can form a contacting portion to mate with corresponding contacts in a corresponding connector. In these and other embodiments of the present invention, an additional bend of approximately 270 degrees can be stamped in front ends of the contacts. This can help to prevent the front ends of the contacts from snagging or getting caught on structures in the corresponding connector. These rods can also be stamped to have two bends of approximately 90 degree near each other. These two stamped bends can provide a vertical displacement between the tail portions (which can be soldered to a board) and the contacting portions of the contacts. This can help to simplify connector assembly.

In these and other embodiments of the present invention, the structure used to form contacts can be a cylindrical rod, or it can have a conical or other shape. The cylindrical or conical shapes used in these examples can provide several benefits. For example, since these shapes have a circular cross-section, there are no sharp points or edges. Thus, the stress provided by the rods to the housing is not concentrated at a point (corner) but is instead dispersed along an outside curved edge of the rod. Also, plating layers can avoid the buildup (or thinning) that can otherwise form at corners of a contact (when present.) However, since a rod maintains a constant thickness along its length, stress can gradually build up in the contact itself towards its tail portion. For that reason, the rod can be formed to be thinner near its front end such that it tapers out and has a larger diameter towards the rear. Also, in these and other embodiments of the present invention, other structures can be used instead of those having a cylindrical or conical shape. For example, tapered rectangular parallelepipeds, truncated pyramids, frustums, elliptical cylinders, truncated elliptical cones, rectilinear parallelepipeds, or other shapes can be used as a structure that is stamped to form contacts. Other elongated structures, such as those having rectangular, rounded rectangular, or other cross-sections can be used as well.

In these and other embodiments of the present invention, side ground contacts and other connector structures can be formed in various ways of various materials. For example, they can be formed by stamping, coining, metal-injection molding, machining, micro-machining, 3-D printing, or other manufacturing process. They can be formed of stainless steel, steel, copper, copper titanium, phosphor bronze, palladium, palladium silver, or other material or combination of materials, as described herein. They can be plated or coated with nickel, gold, palladium, or other material, as described herein. The nonconductive portions, such as the housings and other portions, can be formed using injection or other molding, 3-D printing, machining, or other manufacturing process. The nonconductive portions can be formed of silicon or silicone, Mylar, Mylar tape, rubber, hard rubber, plastic, nylon, elastomers, liquid-crystal polymers (LCPs), ceramics, or other nonconductive material or combination of materials.

Embodiments of the present invention can provide connectors, connector portions, and contacts that can be located in, or can connect to, various types of devices, such as portable computing devices, tablet computers, desktop computers, laptops, all-in-one computers, wearable computing devices, cell phones, smart phones, media phones, storage devices, keyboards, covers, cases, portable media players, navigation systems, monitors, power supplies, adapters, remote control devices, chargers, and other devices. These connectors and contacts can provide pathways for signals that are compliant with various standards such as Universal Serial Bus (USB), such as a USB Type-A or USB Type-C, High-Definition Multimedia Interface® (HDMI), Digital Visual Interface (DVI), Ethernet, DisplayPort, Thunderbolt™, Lightning®, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these interconnect paths provided by these connectors and contacts can be used to convey power, ground, signals, test points, and other voltage, current, data, or other information.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates an electronic system according to an embodiment of the present invention;

FIG. 2 illustrates a portion of a connector according to an embodiment of the present invention;

FIG. 3 illustrates another portion of a connector according to an embodiment of the present invention;

FIG. 4 through FIG. 11 illustrate methods of manufacturing contacts and connector portions according to embodiments of the present invention; and

FIG. 12 illustrates a more detailed view of a group of contacts according to an embodiment of the present invention.

### DESCRIPTION OF ILLUSTRATIVE EMBODIMENTS

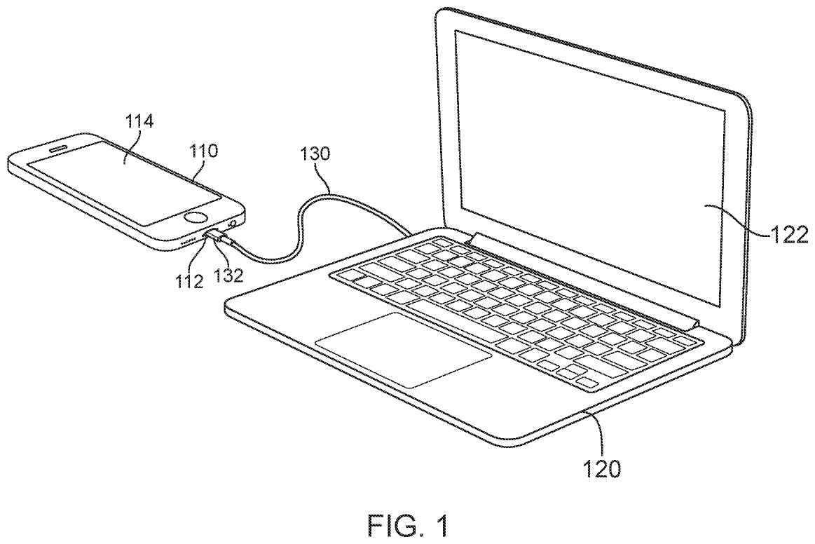

FIG. 1 illustrates an electronic system that can be improved by the incorporation of embodiments of the present invention. This figure, as with the other included figures, is shown for illustrative purposes and does not limit either the possible embodiments of the present invention or the claims.

In this example, electronic device 110 can be connected to electronic device 120 in order to share data, power, or both. Electronic device 110 can communicate and share power with electronic device 120 over a cable, shown here as cable 130. Cable 130 can be one of a number of different types of cables. For example, cable 130 can be a Universal Serial Bus (USB) cable, such as a USB Type-A cable or USB Type-C cable, HDMI®, Thunderbolt™, DisplayPort, Lightning®, or other type of cable. Cable 130 can include corresponding connector insert 132 that plugs into connector receptacle 112 on electronic device 110 and a connector receptacle (not shown) on electronic device 120.

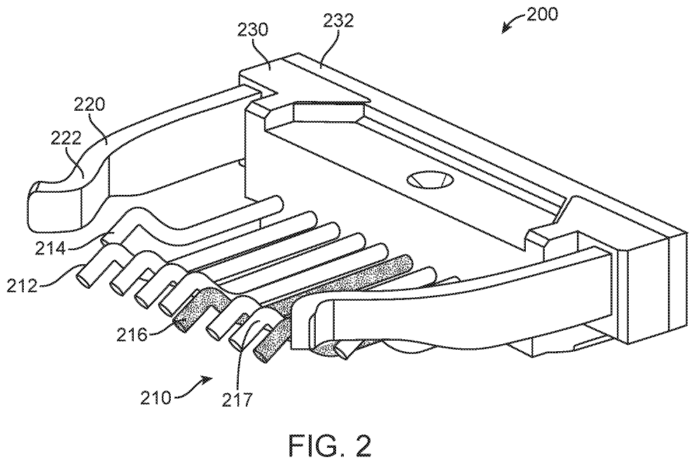

Connector receptacle 112 on electronic device 110 can include a number of contacts 210 (shown in FIG. 2.) Electronic devices, such as electronic device 110, might be dropped in water, they might encounter saltwater, or they might be otherwise exposed to corrosive liquids or materials. These corrosive liquids or materials can corrode contacts 210 in their connector receptacles. This can damage or degrade the connection between electronic device 110 and electronic device 120, thereby rendering electronic device 110 at least partially inoperative.

In this particular example, electronic device 110 can be a smart phone having screen 114, while electronic device 120 can be a portable computer having screen 122. In these and other embodiments of the present invention, electronic device 110 and electronic device 120 can be other types of electronic devices. For example, they can be portable computing devices, tablet computers, desktop computers, laptops, all-in-one computers, wearable computing devices, smart phones, storage devices, portable media players, navigation systems, monitors, power supplies, video delivery systems, adapters, remote control devices, chargers, or other electronic devices.

In these various devices, it can be desirable to prevent, limit, or reduce the corrosion of contacts 210 in connector receptacle 112. Accordingly, embodiments of the present invention can provide connectors having one or more corrosion resistant contacts. Examples are shown in the following figures.

FIG. 2 illustrates a portion of a connector according to an embodiment of the present invention. In this example, connector portion 200 can be used as a portion of connector receptacle 112 in electronic device 110 (shown in FIG. 1), as a portion of connector insert 132 of cable 130 (shown in FIG. 1), or as a portion of another connector in a connector system. In this example, contacts 216 (or more specifically, substrates of contacts 216) can be formed of a precious material, such as a precious metal or precious-metal alloy. When substrates for contacts 216 are formed of a precious-metal alloy, they can be formed of a high-entropy alloy. For example, they can be formed of material consistent with one of ASTM Standards B540, B541, B563, B589, B683, B685, or B731. They can be formed of gold, a gold alloy such as yellow gold, silver, a silver alloy, rhodium, rhodium alloy, ruthenium, ruthenium alloy, rhodium-ruthenium, rhodium-iridium, other platinum group elements such as palladium, osmium, iridium, and platinum, other precious metals and their alloys, or other materials. The contact substrates can also or instead be formed using other materials such as niobium or tantalum and their alloys. Materials having a good formability and high elongation for improved manufacturability can be selected for use as the precious-metal alloy.

In these and other embodiments of the present invention, these precious materials can be conserved. For example, in connector portion 200, contacts 216 can be formed of a precious material while contacts 212 and 214 (or more specifically, their substrates) can be formed of a more common or readily available material, such as copper, copper-nickel-silicon, or other copper alloy, aluminum, aluminum alloy, stainless steel, titanium, titanium alloy or other material. These contact substrates can also or instead be formed using other materials such as niobium or tantalum and their alloys. By forming substrates for contacts 216 out of a precious material and contacts 212 and 214 of a more common material, the usage of precious material in manufacturing connector portion 200 can be reduced.

The corrosion of contacts in a connector can be exacerbated by the presence of voltages on those contacts. In these and other embodiments of the present invention, contacts 216 can be used to convey high voltages. For example, contacts 216 can be used to convey and receive power supply voltages. For this reason, contacts 216 can be formed of a precious material. Conversely, contacts 212 and 214 can be used to convey ground, data signals, and other lower-voltage signals, and therefore can be formed of a more common material. Using precious materials for only some contacts can reduce an amount of precious material used in forming connector portion 200.

As one specific example, in a Lightning® connector receptacle, contacts for some or all of a power supply VBUS (pin 5), an accessory power supply ACC_PWR (pin 8), and an accessory identification pin ACC_ID (pin 4) can be formed using a precious metal or a precious-metal alloy or other material, while the remaining pins can be formed of a more common material. In a Universal Serial Bus Type-C connector insert, contacts for all or some of a power supply VBUS (pins A4, A9, B4, B9, connection detect CC1 (pin A5), and connector power VCONN (B5) can be formed using a precious metal or a precious-metal alloy or other material, while the remaining pins can be formed of a more common material.

Connector portion 200 can include housing 230, which can be injection molded around midsections of contacts 212, 214, and 216. Housing 230 can be fixed in place in an electronic device by glue or adhesive 232. Housing 230 can further support other connector structures. In this example, housing 230 can support side ground contacts 220. Side ground contacts 220 can include contacting portions 222. Contacting portions 222 can physically and electrically contact a shield of a corresponding connector (not shown) when the corresponding connector (such as a connector insert or connector receptacle) is mated with a connector (not shown) that includes connector portion 200 (such as a connector receptacle or connector insert.) For example, where connector portion 200 is part of connector receptacle 112 in the electronic device 110, contacting portions 222 can physically and electrically contact the shield (not shown) of corresponding connector insert 132 when connector insert 132 is inserted into connector receptacle 112. Similarly, contacting portions 217 of contacts 212, 214, and 216 can physically and electrically contact corresponding contacts (not shown) in connector insert 132 when connector insert 132 is inserted into connector receptacle 112.

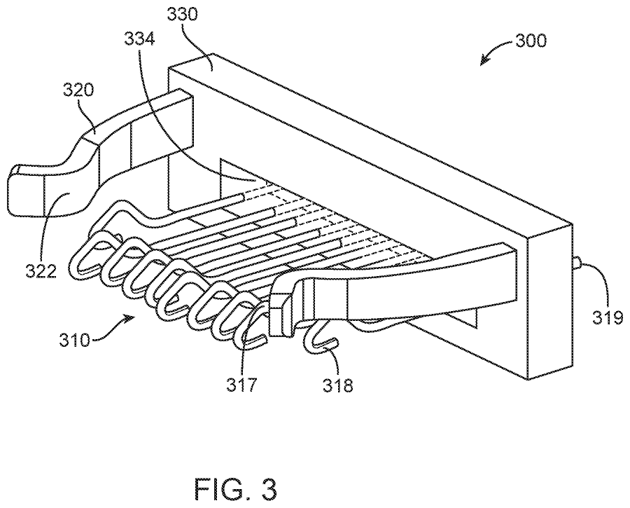

FIG. 3 illustrates another portion of a connector according to an embodiment of the present invention. In this example, connector portion 300 and its components can be the same or similar to connector portion 200, and can be used as a portion of connector receptacle 112 in electronic device 110 (shown in FIG. 1), as a portion of connector insert 132 of cable 130 (shown in FIG. 1), or as a portion of another connector in a connector system. In this example, one or more contacts 310 can be formed of a precious material. One or more contacts 310 can also or instead be formed using other materials such as niobium or tantalum. Contacts 310 can have an additional bend to form front end 318. This can help to prevent contacts 310 from snagging or getting caught on structures in a corresponding connector. Contacts 310 can have contacting portions 317 that are at least somewhat rounded. In these and other embodiments of the present invention, contacts 310 can have contacting portions 317 that have a different shape. For example, contacting portions 317 can have a flatter shape, or they can have a sharper, more pointed shape.) A midsection of each contact 310 can be encased in a glass portion 334 of housing 330. Tail portions 319 can extend from a rear of housing 330. Glass portion 334 can be particularly useful in forming a hermetic seal around midsections of contacts 310. This can prevent moisture and other types of ingress into electronic device 110 when connector portion 300 is used in connector receptacle 112.

As before, housing 330 can support side ground contacts 320. Side ground contacts 320 can include contacting portions 322. Contacting portions 322 can physically and electrically contact a shield of a corresponding connector. For example, where connector portion 300 is part of connector receptacle 112 in the electronic device 110, contacting portions 322 can physically and electrically contact the shield (not shown) of corresponding connector insert 132 when connector insert 132 is inserted into connector receptacle 112. Similarly, contacts 310 can physically and electrically contact corresponding contacts (not shown) in connector insert 132 when connector insert 132 is inserted into connector receptacle 112.

Embodiments of the present invention can reduce the usage of precious materials by stamping a structure that becomes a contact instead of stamping a contact from a structure. For example, conventional contacts can be stamped from a sheet of metal. The stamped contacts can have the right shape to be used in a connector, but remains of the sheet of metal must be recycled if the metal is to be used again. Instead of stamping contacts from a sheet of metal, embodiments of the present invention can provide a structure, such as a rod or cylinder, and then stamp the rod or cylinder into a shape needed to be used as a contact in a connector. This can reduce the amount of precious materials that are needed to manufacture contacts for a connector, thereby conserving valuable resources. Conserving these precious materials can allow the use of better materials for the contacts to further reduce corrosion. Methods of manufacturing these contacts are shown in the following figures.

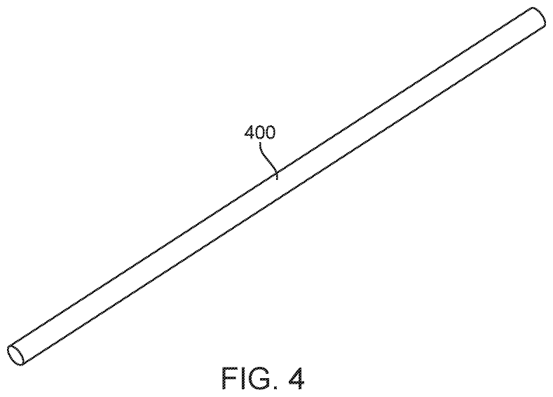

FIG. 4 through FIG. 9 illustrate methods of manufacturing contacts and connector portions according to embodiments of the present invention. In FIG. 4, rod 400 can be provided. Rod 400 can be formed by extrusion, 3-D printing, metal-injection molding, or other additive or other process.

In these and other embodiments of the present invention, the structure used to form contacts 210 (shown in FIG. 2) and contacts 310 (shown in FIG. 3) can be a cylindrical rod 400, or it can have a conical or other shape. The cylindrical or conical shapes used in these examples can provide several benefits. For example, since these shapes have a circular cross-section, there are no sharp points or edges. Thus, the stress provided by rods 400 to housing 230 (shown in FIG. 2) or housing 330 (shown in FIG. 3) is not concentrated at a point (corner) but is instead dispersed along an outside edge of rod 400. This can help to avoid cracking or damage to housing 230 and housing 330, particularly to glass portion 334 (shown in FIG. 3) of housing 330. Also, plating layers can avoid the buildup (or thinning) that can otherwise form at corners of a contact. However, since rod 400 maintains a constant thickness along its length, stress can gradually build up in the contact itself towards its tail portion 219 (shown in FIG. 2.) For that reason, rod 400 can be stamped to be thinner near the front end such that it tapers out towards the rear. Also, in these and other embodiments of the present invention, other structures can be used instead of those having a cylindrical or conical shape. For example, tapered rectangular parallelepipeds, truncated pyramids, frustums, elliptical cylinders, truncated elliptical cones, rectilinear parallelepipeds, or other shapes can be used as a structure that is stamped to form contacts 210 and 310. Other elongated structures, such as those having rectangular, rounded rectangular, or other cross-sections can be used to form contacts 210 and 310 as well.

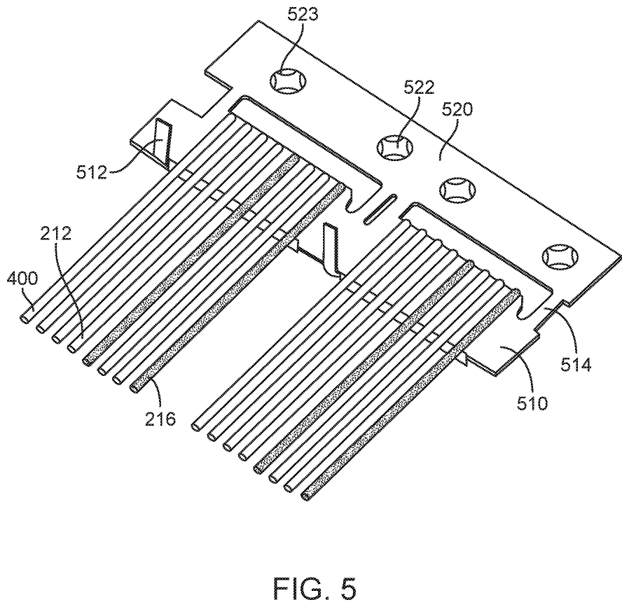

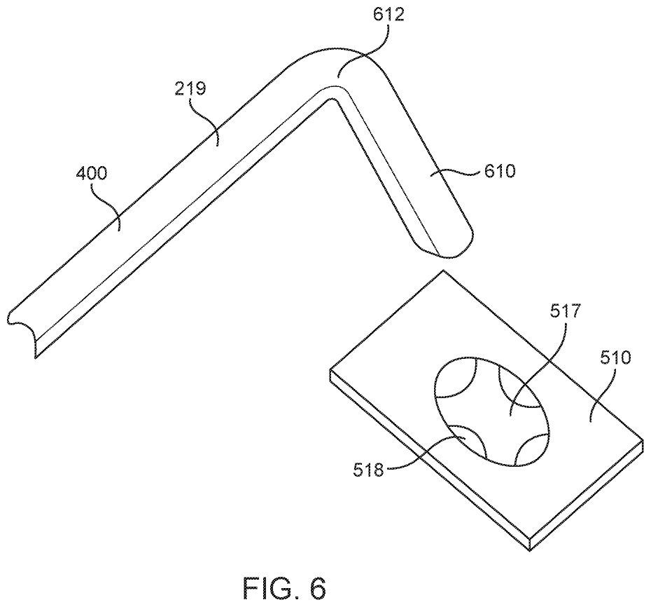

A rod 400 that is formed of a precious material can be used as a contact 216. A rod 400 that is instead formed of a more common material can be used as a contact 212 or a contact 214. Shown in FIG. 5, these rods 400 can be attached to carrier 510. Carrier 510 can be attached through bridges 514 to guide portion 520. Guide portion 520 can include openings 522 that can be used to mechanically move and position carrier 510 and rods 400 during further manufacturing steps. Openings 522 can have securing projections 523, which can be similar to securing projections 518 in FIG. 6 below. Carrier 510 can also include alignment feature 512. Rods 400 can be attached to carrier 510 by press fitting, stitching, or other method. Carrier 510 can have holes or other openings into, or through which, rods 400 can be inserted. An example is shown in the following figure.

In these and other embodiments of the present invention, rods 400 can be inserted into openings in carrier 510. For example, in FIG. 6, rod 400 can be attached to carrier 510. Tail portion 219 of rod 400 can be compressed to be at least somewhat flatter than a cylinder. End 610 of rod 400 can be bent at location 612. End 610 can be inserted into opening 517 in carrier 510. Opening 517 can include securing projections 518, which can have a reduced thickness as compared to carrier 510. During insertion, end 610 of rod 400 can push securing projections 518 downward. In this way, securing projections 518 can help to secure end 610 in place in opening 517 of carrier 510. Opening 517 can have a shape to at least approximately match a cross-section of end 610 of rod 400. This can further help to secure end 610 of rod 400 in place in opening 517 of carrier 510.

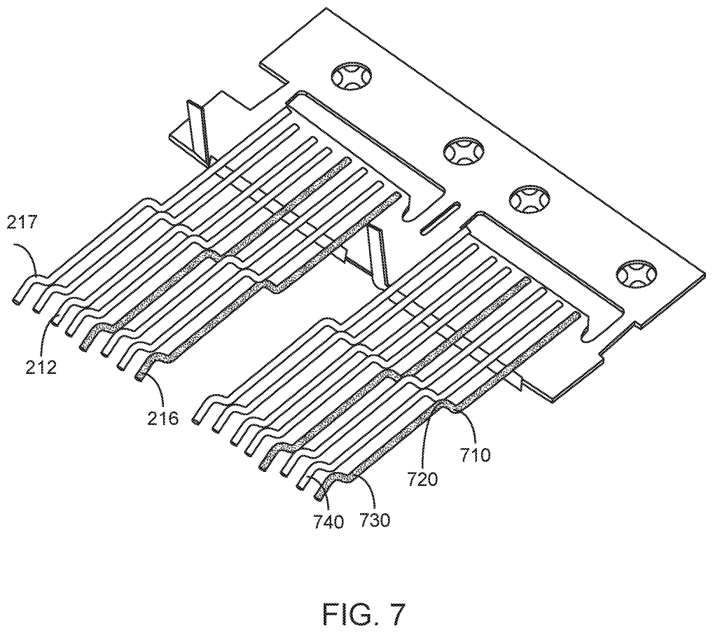

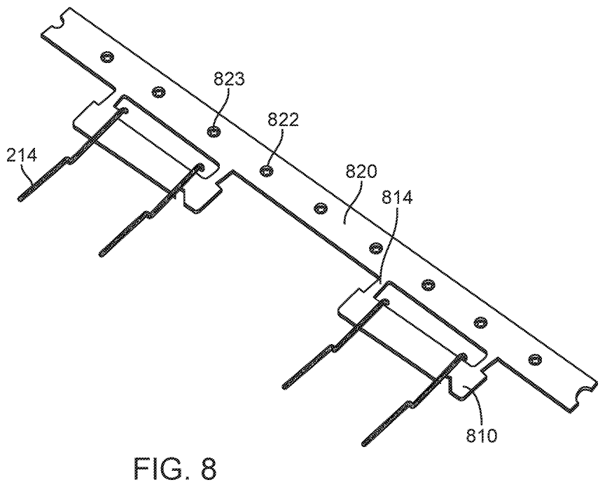

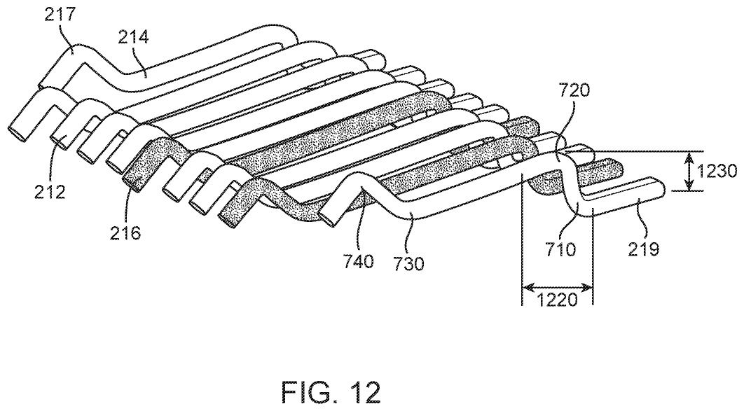

In FIG. 7, rods 400 (shown in FIG. 5) can be stamped to form contacts 212 and 216. In this example, contacts 212 and 216 can include two stamped bends 710 and 720 that are nearly at right angles. These two stamped bends 710 and 720 can provide a vertical displacement between tail portions 219 of contacts 212 and 216, and contacting portion 217 formed by stamped bends 730 and 740. These shapes are explored further below in FIG. 12. In FIG. 8, contacts 214 have been attached to carriers 810 and then stamped. Contacts 214 can be attached to carrier 810 by press fitting, stitching, or other method. Carrier 810 can have holes or other openings into, or through which, contacts 214 can be inserted. Carriers 810 can be connected through bridges 814 to guide portion 820. Guide portion 820 can include openings 822 that can be used to mechanically move and position carrier 810 and contacts 214 for further manufacturing steps. Openings 822 can include securing projections 823, which can be the same or similar to securing projections 518 in FIG. 6. Contacts 214 can be attached to carrier 810 in the same or a similar manner as contacts 212 and 216 are attached to carrier 510 (shown in FIG. 6.)

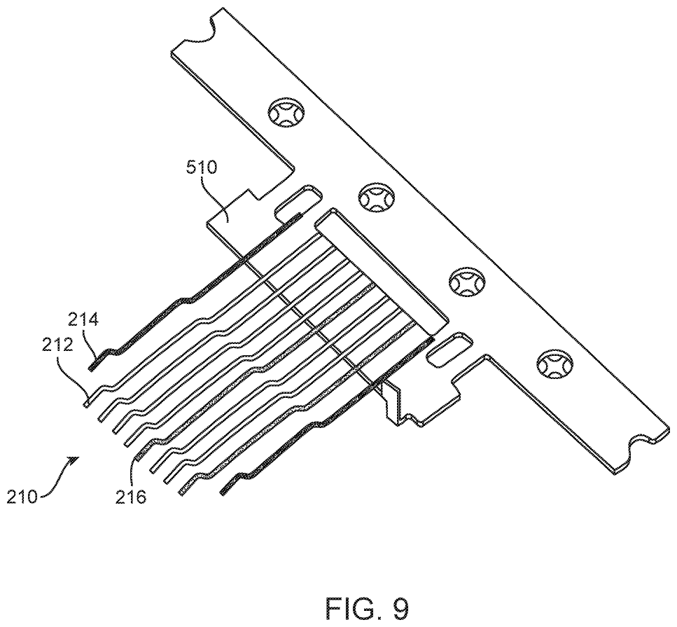

In FIG. 9, carriers 510 and 810 can be joined to form groups of contacts 210. Groups of contacts 210 can include contacts 212, 214, 216. The groups of contacts 210 can be plated at this point, though the plating can be done with the different types of contacts at different stages of manufacturing. In these and other embodiments of the present invention, these contacts can be plated with a hard, durable, wear and corrosion resistant plating stack (not shown.) This stack can be formed of one or more plating layers.

This stack can include a top plate that forms a contacting surface to physically and electrically connect to a corresponding contact in a corresponding connector. The top plate can be formed of rhodium, rhodium alloy, ruthenium, ruthenium alloy, rhodium-ruthenium, rhodium-iridium, or other platinum group elements such as palladium, osmium, iridium, and platinum, and their alloys, B540, B541, B563, B589, B683, B685, or B731, titanium, titanium alloy, gold, gold alloy, silver, silver alloy, gold-cobalt, gold-copper, yellow gold, or other precious metal or its alloys. Halides, such as dark rhodium or dark ruthenium, can also be used. This top plate can have a thickness between 0.3 and 0.8 microns, between 0.5 and 1.0 microns, or between 0.6 and 1.5 microns. The top plate can have a thickness of 0.5, 0.6, 0.7, 0.8, 1.0, 1.5, more than 1.5 microns, or it can have another thickness.

A barrier layer of electroless nickel, nickel, nickel-tungsten; tin-nickel, nickel-copper, tin-copper-nickel, silver, palladium, nickel phosphate, or other material can be formed over contacts 212, 214, 216 before the top plate is formed. This barrier layer can have a thickness between 0.5 and 0.1.5 microns, between 1.0 and 1.5 microns, between 2.0 and 2.5 microns, between 1.0 and 3.0 microns, or between 2.0 and 4.0 microns. The barrier layer can have a thickness of 1.0, 1.5, 2.0, 2.5, 3.0, 3.5, or more than 3.5 microns, or it can have another thickness.

A first gold flash can be used between the barrier layer and the top plate as an adhesion layer. This first gold flash adhesion layer can have a thickness between 0.03 and 0.08 microns, between 0.05 and 0.10 microns, or between 0.06 and 0.15 microns. The first gold flash adhesion layer can have a thickness of 0.05, 0.06, 0.07, 0.08, 0.10, 0.15, more than 0.15 microns, or it can have another thickness.

An isolation layer can be plated over the contacts before the barrier layer is formed. This isolation layer can be copper, electroless nickel, nickel, nickel-tungsten; tin-nickel, tin-copper-nickel, silver, palladium, or other material. This isolation layer can have a thickness between 0.5 and 0.1.5 microns, between 1.0 and 1.5 microns, between 2.0 and 2.5 microns, between 1.0 and 3.0 microns, or between 2.0 and 4.0 microns. The isolation layer can have a thickness of 1.0, 1.5, 2.0, 2.5, 3.0, 3.5, or more than 3.5 microns, or it can have another thickness.

A second gold flash can be used between the isolation layer and the barrier layer as an adhesion layer. This second gold flash adhesion layer can have a thickness between 0.03 and 0.08 microns, between 0.05 and 0.10 microns, or between 0.06 and 0.15 microns. The second gold flash adhesion layer can have a thickness of 0.05, 0.06, 0.07, 0.08, 0.10, 0.15, more than 0.15 microns, or it can have another thickness.

A first or leveling layer can be plated over the contacts before the isolation layer is formed. This first or leveling layer can be copper, electroless nickel, nickel, nickel-tungsten; tin-nickel, tin-copper-nickel, silver, palladium, or other material. This first or leveling layer can have a thickness between 0.5 and 0.1.5 microns, between 1.0 and 1.5 microns, between 2.0 and 2.5 microns, between 1.0 and 3.0 microns, or between 2.0 and 4.0 microns. The first or leveling layer can have a thickness of 1.0, 1.5, 2.0, 2.5, 3.0, 3.5, or more than 3.5 microns, or it can have another thickness.

Other layers, such as a sacrificial layer, can be included in this plating stack as well, and one or more of the above layers can be omitted in these and other embodiments of the present invention. For example, where the substrate is a precious metal or precious-metal alloy, the leveling and isolation layers can be omitted. Where the substrate is a precious metal or precious-metal alloy, all plating layers can be omitted in the contacting portions 217 or 317, or the plating layers can be reduced to a top plate and a first gold flash between the top plate and the precious metal or precious-metal alloy substrate or other simplified plating stack. Similarly, the plating over tail portions 219 of some or all of these contacts 212, 214, and 216 can be simplified to a gold flash, to a gold flash over an isolation layer, to a gold flash over an isolation layer over a leveling layer, or other reduced set of plating layers. A gold flash over a layer including nickel can be used to facilitate the soldering of tail portions 219 to a board or other appropriate substrate (not shown.)

These plating layers can be formed at various times in the manufacturing process. For example, contacts 212 and 216 can be plated after the steps represented by FIG. 7, contacts 214 can be plated after the steps represented by FIG. 8, or contacts 212, 214, and 216 can be plated after the steps represented by FIG. 9. Contacts 212 and 216 can be plated or partially plated at different times. For example, contacts 216 can be formed of a precious metal or precious-metal alloy and as such might not receive a leveling or isolation plating, while contacts 212 can be formed of a more common material and can be plated with these layers. Both contacts 212 and 216 can then be plated with a second adhesion layer, a barrier layer, a first adhesion layer, and a top plate, as described above. In these and other embodiments of the present invention, contacts 216 can be plated with a leveling layer, isolation layer, second adhesion layer, and a barrier layer, then both contacts 212 and 216 can be plated with the first adhesion layer and top plate.

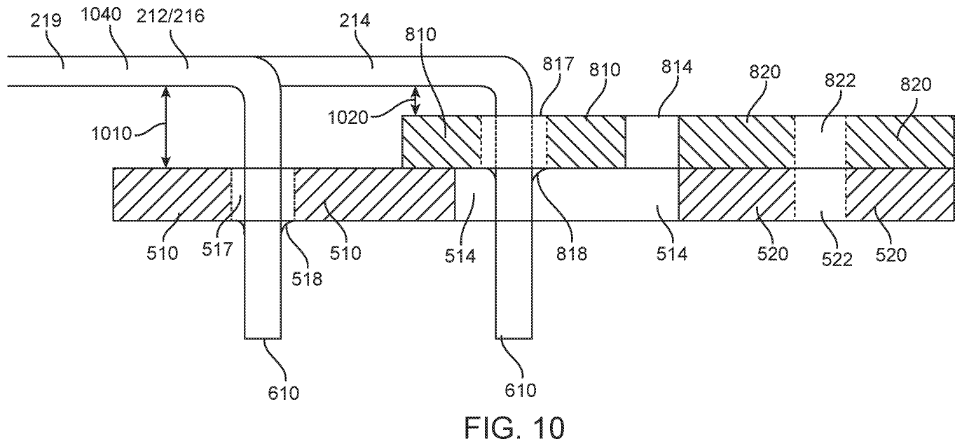

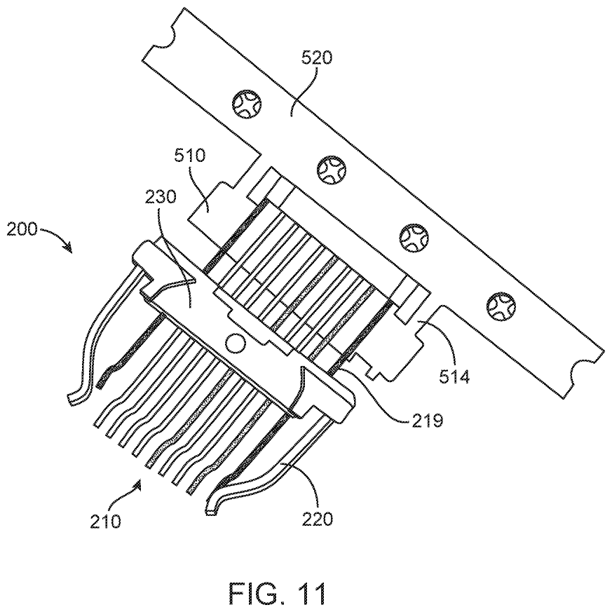

Again, carrier 510 and contacts 212 and 216, and carrier 810 and contacts 214, can be joined to form groups of contacts 210. A cross-section showing how this can be done is shown in FIG. 10. In FIG. 10, ends 610 of tail portions 219 of contacts 212 and contacts 216 have been inserted into openings 517 in carrier 510, as shown in FIG. 6. Securing projections 518 have been bent downward and can help to secure ends 610 of tail portions 219 in place in carrier 510. Similarly, ends 610 of contacts 214 have been inserted into openings 817 in carrier 810. Supporting projections 818 have been pushed downward and can help to secure ends 610 of tail portions 219 in place in carrier 810. Carrier 810 can be attached through bridge 814 to guide portion 820. Guide portion 820 can be stacked on guide portion 520 such that opening 822 in guide portion 820 is aligned with opening 522 in guide portion 520. Carrier 510 can be attached to guide portion 520 through bridge 514. Tail portions 219 of contacts 212 and 216 can be positioned with a relative height 1010 that is more than a relative height 1020 at which tail portions 219 of contacts 214 are positioned relative to carrier 810. This can allow tail portions 219 of contacts 212, 214, and 216 to be located in a same horizontal plane. Following this, the contacts can be aligned to each other using a tool. This tool can further be used in forming a housing around contacts 212, 214, and 216, as shown in the FIG. 11 below.

Contacts 212, 214, and 216, can be trimmed at or near location 1040. As such, a longer length of contacts 214 is recycled after trimming as compared to contacts 212 and 216. More specifically, ends 610 and portions of tail portions 219 can be recycled, along with carriers 510 and 810. Since there are fewer contacts 214, this positioning of carriers 810 and 510 can help to reduce a total amount of material used to form contacts 212, 214, and 216 that needs to be recycled. Also, since contacts 216 can be formed of a precious material, less precious material needs to be recycled.

In FIG. 11, housing 230 can be injection molded around midsections of contacts 210. Housing 230 can also support side ground contacts 220. Contacts 210 can be cut along tail portions 219 to separate connector portion 200 from carrier 510. That is, group of contacts 210 can then be cut or otherwise detached from the carrier 510 such that housing 230, group of contacts 210, and side ground contacts 220 or other connector structures can be assembled into a connector.

In these and other embodiments of the present invention, the order of these steps can be rearranged, some steps can be omitted, and others can be added. For example, contacts 210 can be stamped and then placed in a mold for housing 230. Housing 230 can then be injection molded around midsections of contacts 210. In this example, carriers 510 and 710 might not be needed.

FIG. 12 illustrates a more detailed view of a group of contacts according to an embodiment of the present invention. This example includes contacts 212, 214, and 216. These contacts can have tail portions 219. Tail portions 219 can be flattened (or at least made flatter) to improve a solder connection between tail portions 219 of contacts 212, 214, and 216 and a board, where the board can be a printed circuit board, flexible circuit board, or other appropriate substrate. Contacts 212, 214, and 216 can include contacting portion 217 formed by stamped bends 730 and 740. These bends can include bend 730, which can be at an angle of approximately 45 degrees. For example, bend 730 can be in the range of 30 to 60 degrees. These bends can also include bend 740, which can be at an angle of approximately 90 degrees. For example, bend 740 can be in the range of 60 to 110 degrees. These bends can form a raised portion that can physically and electrically connect with a corresponding contact in a corresponding connector. Contacts 212, 214, and 216 can further include stamped bends 710 and 720. These bends can be approximately 90 degrees. For example, these bends can be between 60 degrees and 90 degrees. These bends can form a vertical displacement 1230 that can offset a location of the contacting portions 217 from tail portions 219. This can make the placement of connector portions 200 and 300 easier to fit with other portions of connector receptacle 112 of electronic device 110 (shown in FIG. 1.) In these and other embodiments of the present invention, a midsection, shown here as midsection 1220, can be housed in housing 230 or 330, as shown in FIG. 2 and FIG. 3.

In these and other embodiments of the present invention, other plating layers, such as barrier layers to prevent corrosion, can be included. For example, barrier layers, such as zinc barrier layers, can be used to protect contacts from corrosion by cladding or plating layers. Catalyst layers can be used to improve the rate of deposition for other layers, thereby improving the manufacturing process. These catalyst layers can be formed of palladium or other material. Stress separation layers, such as those formed of copper, can also be included in these and other embodiments of the present invention. Other scratch protection, passivation, and corrosion resistance layers can also be included.

In these and other embodiments of the present invention, side ground contacts and other connector structures can be formed in various ways of various materials. For example, they can be formed by stamping, coining, metal-injection molding, machining, micro-machining, 3-D printing, or other manufacturing process. They can be formed of stainless steel, steel, copper, copper titanium, phosphor bronze, palladium, palladium silver, or other material or combination of materials, as described herein. They can be plated or coated with nickel, gold, palladium, or other material, as described herein. The nonconductive portions, such as the housings and other portions, can be formed using injection or other molding, 3-D printing, machining, or other manufacturing process. The nonconductive portions can be formed of silicon or silicone, Mylar, Mylar tape, rubber, hard rubber, plastic, nylon, elastomers, liquid-crystal polymers (LCPs), ceramics, or other nonconductive material or combination of materials.

Embodiments of the present invention can provide connectors and contacts that can be located in, or can connect to, various types of devices, such as portable computing devices, tablet computers, desktop computers, laptops, all-in-one computers, wearable computing devices, cell phones, smart phones, media phones, storage devices, keyboards, covers, cases, portable media players, navigation systems, monitors, power supplies, adapters, remote control devices, chargers, and other devices. These connectors and contacts can provide pathways for signals that are compliant with various standards such as Universal Serial Bus, High-Definition Multimedia Interface®, Digital Visual Interface, Ethernet, DisplayPort, Thunderbolt™, Lightning®, Joint Test Action Group, test-access-port, Directed Automated Random Testing, universal asynchronous receiver/transmitters, clock signals, power signals, and other types of standard, non-standard, and proprietary interfaces and combinations thereof that have been developed, are being developed, or will be developed in the future. In various embodiments of the present invention, these interconnect paths provided by these connectors and contacts can be used to convey power, ground, signals, test points, and other voltage, current, data, or other information.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A connector receptacle comprising:
a first plurality of contacts, each formed of a cylindrical rod comprising a first material and bent to have a first shape;
a second plurality of contacts, each formed of a cylindrical rod comprising a second material, the second material different from the first material, and bent to have the first shape; and
a housing around a midsection of each of the first plurality of contacts.

2. The connector receptacle of claim 1 further comprising a first side ground contact on a first side of the first plurality of contacts and the second plurality of contacts and a second side ground contact on a second side of the first plurality of contacts and the second plurality of contacts.

3. The connector receptacle of claim 1 wherein the first plurality of contacts and the second plurality of contacts each have a tail portion, where the tail portion is flattened to improve a solder connection to a board.

4. The connector receptacle of claim 1 wherein the first plurality of contacts and the second plurality of contacts are each bent to include a vertical displacement and a contacting portion.

5. The connector receptacle of claim 1 wherein the first material comprises a material consistent with one of ASTM Standards B540, B563, B589, B683, B685, or B731.

6. The connector receptacle of claim 5 wherein the second material comprises a copper alloy.

7. The connector receptacle of claim 5 wherein the second material comprises copper-nickel-silicon.

8. The connector receptacle of claim 1 wherein the first material comprises a material consistent with ASTM Standard B540.

9. The connector receptacle of claim 1 wherein the first plurality of contacts are used to convey power supply voltages.

10. The connector receptacle of claim 1 wherein the first plurality of contacts and the second plurality of contacts are each plated with a top-plate of rhodium-ruthenium.

11. A method of manufacturing a connector, the method comprising:
receiving a first plurality of rods formed of a first material;
receiving a second plurality of rods formed of a second material;
stamping the first plurality of rods to form a first plurality of contacts;
stamping the second plurality of rods to form a second plurality of contacts; and
forming a housing around midsections of the first plurality of contacts and the second plurality of contacts.

12. The method of claim 11 wherein the housing is further formed to support a first side ground contact on a first side of the first plurality of contacts and the second plurality of contacts and a second side ground contact on a second side of the first plurality of contacts and the second plurality of contacts.

13. The method of claim 12 further comprising flattening a tail portion of each of the first plurality of contacts and the second plurality of contacts to improve a solder connection to a board.

14. The method of claim 11 further comprising bending each of the first plurality of contacts and the second plurality of contacts to include a vertical displacement and a contacting portion.

15. The method of claim 11 wherein the first material comprises a material consistent with one of ASTM Standards B540, B563, B589, B683, B685, or B731.

16. The method of claim 15 wherein the second material comprises a copper alloy.

17. The method of claim 15 wherein the second material comprises copper-nickel-silicon.

18. The method of claim 11 wherein the first material comprises a material consistent with ASTM Standard B540.

19. The method of claim 11 wherein the first plurality of contacts are used to convey power supply voltages.

20. The method of claim 11 further comprising plating the first plurality of contacts and the second plurality of contacts with a top-plate of rhodium-ruthenium.

21. A connector receptacle comprising:
a first plurality of contacts, each formed of an elongated structure comprising a first material and bent to have a first shape;
a second plurality of contacts, each formed of an elongated structure comprising a second material, the second material different from the first material, and bent to have the first shape; and
a housing around a midsection of each of the first plurality of contacts.

22. The connector receptacle of claim 21 wherein each elongated structure has a rectangular cross-section.

23. The connector receptacle of claim 21 wherein each elongated structure has a rounded rectangular cross-section.

24. The connector receptacle of claim 21 wherein each elongated structure has a circular cross-section.
